(19) United States
(12) Patent Application Publication
(10) Pub. No.: US 2009/0178598 A1
(43) Pub. Date: Jul. 16, 2009

(54) Centralized electronic safe and accounting control system including configurable deposit and cash dispensing authority and armored car transaction automation

(76) Inventor: Scott Meeker, Winchester, CA (US)

Correspondence Address: JAMES M. FRANCIS, 300 W VINE ST, STOLL KEENON OGDEN PLLC, LEXINGTON, KY, 40507, US

(21) Appl. No.: 12/014,766

(22) Filed: Jan. 16, 2008

(51) Int. Cl. E05G 1/026

(52) U.S. Cl. 109/64

(57) ABSTRACT

A cash room automation device comprising, at least one safe comprising; a housing having an interior compartment for securing money, and an outer door having an electronic lock mechanism to control access to said interior compartment. The device has a control system which controls the electronic lock, a control system user interface, a cash recycler controlled by the control system and housed within the safe. The cash recycler is capable of authenticating and assigning value to paper currency fed into said cash recycler through a paper currency port accessible from outside said safe and capable of accepting and dispensing a plurality of said paper currency of differing denominations in a single transaction. The paper currency port housing protrudes from the safe so as to extend from a secure cash room to a cashier's area. The control system also posseses means to integrate peripheral units with said control system. The device can also automate armored car transactions through the automatic generation of a manifest.

### RELATED APPLICATIONS

The present application relates to and claims priority with regard to all common subject matter of provisional patent application titled “Centralized electronic safe and accounting control system including configurable deposit and cash dispensing authority and armored car transaction automation”, Ser. No. 60/884,891 filed Jan. 15, 2007. The identified provisional patent application is hereby incorporated into the present application by reference.

### BACKGROUND OF THE INVENTION

1. Field of the Invention

The present invention relates to cash management systems and devices. More particularly, the present invention relates to cash recyclers and accounting systems that facilitate cash room automation.

2. Problems in the Art

Retailers who see a high volume of cash transactions are susceptible to cashier error and internal theft. Labor expenses and bank fees associated with cash handing also affect retailer's profits. A need exists for a comprehensive cash handling solution that adds security to cash handling activities as well as improves efficiency and accuracy.

Typically, cash is dispensed to fill cashier's tills in the secure cash room of the retailer. It is a slow process prone to human error. The same cash room makes change throughout the day and receives deposits at night. Closing out the cash registers and ultimately getting the store's financial data to the corporate treasury is a vital retailer activity. Another area for improvement is armored car transactions. Fees are based on time spent in the cash room, therefore a quick count and automated generation of a manifest can help to reduce costs.

### SUMMARY OF THE INVENTION

The present invention facilitates cash room automation by acting as the processing and communications hub for various cash management devices and is an all-in-one cash deposit, dispensing and recycling machine. The device also acts as the accounting and communications center for the retail establishment.

In accordance with this and other objects, the present invention provides a back-room cash room automation system having at least one safe that includes a housing having an interior compartment for securing money, and an outer door having an electronic lock mechanism to control access to the interior compartment. The safe also includes a data input device, a control system, an electronic display, a connector interface mounted to the housing, and a control system arranged to communicate with the data input device, electronic display, connector interface and electronic lock. The control system includes a processor programmed to control operation of the electronic lock mechanism, as well as operate as a central system controller when connected to at least one other remote safe via the connector interface to monitor and accumulate financial and operational information for each remote unit. The control system interfaces with back-room accounting and ledger software. Additionally, the device can be accessed and controlled remotely over a wide area network.

The device features a cash room operator's interface and a cashier's kiosk. The device is designed to reside within the secure back-room cash handling room. A protruding cash receiving and dispensing mechanism interfaces with the cash recycler and is accessible to a cashier without entry into the cash room. Separate touch screen interfaces permit access from inside and outside the cash room.

These and other objects, features, and advantages of the present invention will be readily apparent from the following detailed description of the best mode for carrying out the invention when taken in connection with the accompanying drawings.

### BRIEF DESCRIPTION OF THE DRAWINGS

FIG. 1 is an angled perspective view of the preferred embodiment of the device.

FIG. 2 is a perspective view of the preferred embodiment of the device shown in use in a cash room and accessible through the wall of the cash room and extending into a cashiers room.

FIG. 3 is a perspective view of the preferred embodiment of the device with the door open and depicting the cash recycler.

FIG. 4 is a diagram depicting a view of various anticipated connections to accessory devices.

FIG. 5 is a process flow diagram depicting communication between the retail store and an outside corporate location.

FIG. 6 is a process flow diagram depicting the process of closing out the store cash registers and.

FIG. 7 is a perspective view of the cash recycling unit of the preferred embodiment with various bill cassettes to store specific denominations If bills.

FIG. 8 is a flow diagram for the cash recycling process.

FIG. 9 is a flow diagram for the cash vending process.

FIG. 10 is a flow diagram for the method of creating an automated armored car manifest.

### DETAILED DESCRIPTION OF THE INVENTION

The present invention provides a cash room automation device 200 and system 400 which acts as the hub for numerous cash management devices and activities. The device also functionally integrates with back office financial software, such as accounting/ledger software. The device features a lockable safe with an electronic lock that can be opened via a user number and password combination, an electronic key, a Dallas key, biometrics, a swipe card, or combinations thereof of each with which the safe is equipped.

A cash recycler 100 is housed within the primary safe 20. The cash recycler 100 preferably utilizes multiple paper currency storage cassettes 30, i.e. bill cassettes, which store specific denominations of paper currency. Multiple bill cassettes 30 are utilized so that as paper currency 60 is validated by a bill validation mechanism 70 within the cash recycler 100 it is segregated and stored into denomination specific paper currency storage cassettes 30 for later retrieval by a the cash recycler 100 based upon authorized user requests which require the cash room automation device 200 to vend bills in specific denominations. Multiple bill validators 70 or a single bill validator 70 could be utilized with the cash room automation device 200. The use of multiple bill validators 70 could clearly speed up the deposit process. Ideally, the cash recycler 100 can vend a plurality of paper currency 60, i.e. bills or banknotes. Preferably, the more paper currency the cash recycler is able to dispense, the better. One embodiment of the cash room automation device 200 utilizes a cash recycler 100 that can dispense up to between one hundred to one hundred twenty banknotes 60 per transaction in a single stack.

The cash recycler 100 accepts deposits through and vends withdrawals from a paper currency port 90 connected to the cash recycler 100. Deposits are sent to the bill validator 70 for authentication and to assign a value upon the banknote 60. The cash recycler 100 then stacks the banknote within the appropriate paper currency storage cassettes 30. An overflow receptacle 35 receives banknotes 60 after the paper currency storage cassettes 30 become full. Preferably, the control system 10 tracks the number of stored banknotes 60 in each paper currency storage cassette 30 and the control system 10 is preferably configured, i.e. programmed, to not overfill a paper currency storage cassette 30. The process is reversed for vending of banknotes 60. The desired monetary amount is withdrawn from the paper currency storage cassette 30 and “recycled” back to the cashiers to make change or provide starting cash for their till.

A user interface 40 permits the user to interact with the control system 10. The user interface 40 typically includes a touch-screen display 42 with a virtual keyboard, a swipe card reader 44, and often a fingerprint reader 46. Users can also utilize Dallas keys, electronic keys, and keyboard/display combinations in some models. Voice recognition is another example of biometric data that could be utilized to authenticate a user's identification.

The user interacts with the touch-screen 42 to perform functions associated with their level of user authority. One embodiment of the invention allows the business to place the primary safe 20 within the secure cash room 300. The paper currency port 90 is shielded by the paper currency port housing 92 and extends from the primary safe 20 so as to allow it to pass through a cash room wall 310 and permit access to the paper currency port from a cashier accessible area 350. A touch-screen display 42 and other required user interfaces 40 are made accessible within the cashier accessible area 350 to permit cashiers to use the device without entering the secure cash room 300. A second touch-screen display 42 and other required user interfaces 40 are made available on the primary safe 20 and accessible only from the secure cash room 300. This provides an added measure of security by minimizing the number of employees that can access the secure cash room 300.

Each transaction is tracked and recorded by the control system 10 which can provide electronic or paper reports or both depending on the configuration of the device. Security is maintained by the use of user identification data associated by the control system with each authorized user. This user identification data can take the form of a personal identification number (PIN), a password, biometric data such as a fingerprint or voice recognition, a magnetic swipe card bearing the user's data, or a Dallas key assigned to the user.

User privileges can be assigned system wide, by group, i.e. cashiers, managers, etc . . . , and at the level of an individual. User authority is also variable by time and date. Examples of time and date related user authority permissions include initiating a vend lock where the device will not dispense cash during certain hours (this can be further limited by date which permits user privileges to be adjusted to accommodate weekend or seasonal hours when opening and closing times might change). The user's access to fill their till can also be delayed until prescribed times. The An additional configuration would permit a store to adjust the starting cash/coin position for till vends based upon a starting and ending date/time to accommodate varying cash needs for peak hours and peak days as well as minimize risk and cash positions for slow periods. The ability to pre-set vend times and vend amounts can be used to create a “one touch” cash pick up process.

The control system 10 is configured to facilitate armored car transactions by automating the cash counting process and automatically generating a manifest. Each safe, device, unit, and component which stores cash can be uniquely associated with a bar code it receives. Upon scanning the bar code, the control system reports on the stored contents and provides an accurate count of paper currency and/or coin stored and available for removal. Bar coding is also available for paper currency storage cassettes 30 as well as other receptacles or bags. The value of each component removed is debited from the ledger and recorded on the manifest. Likewise, when paper currency storage cassettes 30 are swapped and a desired level of starting cash is required, the value of the paper currency storage cassettes 30 or other receptacle or bag can be uploaded into the system. Required documentation can also be automatically generated.

Optionally, the safe could include a check acceptor 22 (compatible with the Check Clearing for the 21st Century Act (Check 21) standards, possessing a means for reading the check as well as a cash recycler 100. The check reader 22 utilizes a separate entry point and means for reading the routing number and account number on the check. The check acceptor 22 could also be a peripheral unit. The device could be also be fitted with a coin acceptor and sorter 24 in place of the cash recycler 100 or act as a peripheral unit. The control system 10 is configured to communicate with numerous makes and models of peripheral units such as check acceptors 22 and bulk coin dispensers 26. Upon connecting the peripheral unit, the user merely selects the device unknown to the control system 10 from a control system 10 provided list of compatible devices. Once the proper make and model are selected, the control system 10 can translate its commands so that the peripheral device can understand as well as translate data received from the peripheral device. The control system's 10 ability to integrate with numerous makes and models of peripheral devices creates a huge cost savings as existing equipment need not be replaced.

The control system 10 can be housed within the touch-screen display housing 43. A connector interface 80 permits peripheral units, or other devices such as printers, to be functionally integrated with the control system 10 and its associated hardware and software. In some embodiments there may also be a physical integration as well. The connector interface 80 can be physical, such as a universal serial bus receptacle 81 or IEEE 1394 port which accepts cables with standard connectors. The connector interface 80 can also be wireless such as an IEEE 802.11 or IEEE 802.15 connection.

Connections can be networked. Network addresses or device addresses or serial numbers, i.e. unique identifiers visible over the network to the local or remote control system, permit the identification of each connected device. Networking permits the control of each connected device and the download of the transaction history, i.e. ledger and operational history by the local or remote control system. The data downloaded from each device can be keyed to an individual device or group of devices as well as to users.

Computer networks may be implemented using a variety of protocol stack architectures, computer buses or combinations of media and protocol layers. Ideally the system will utilize USB or Wireless USB to connect the external devices to the control system hardware. Additional embodiments could utilize the IEEE 1394 (a/k/a Apple FireWire or Sony iLink) or IEEE 802 standard including but not limited to IEEE 802.3 Ethernet and IEEE 802.15 Wireless PAN.

A wireless connection would typically be an ad hoc network connection. The connection is established for the duration of one session and requires no base station. Instead, devices discover others within range to form a network for those computers. Devices may search for target nodes that are out of range by flooding the network with broadcasts that are forwarded by each node. Connections are possible over multiple nodes (multihop ad hoc network). Routing protocols then provide stable connections even if nodes are moving around.

Wireless is a term used to describe telecommunications in which electromagnetic waves (rather than some form of wire) carry the signal over part or all of the communication path. Fixed wireless refers to the operation of wireless devices or systems in fixed locations such as homes and offices. Fixed wireless devices usually derive their electrical power from the utility mains, unlike mobile wireless or portable wireless which tend to be battery-powered.

IR wireless is another possibility for wireless communication between the control system and peripheral units. IR wireless is the use of wireless technology in devices or systems that convey data through infrared (IR) radiation. IR wireless is used for short- and medium-range communications and control. Some systems operate in line-of-sight mode; this means that there must be a visually unobstructed straight line through space between the transmitter (source) and receiver (destination). Other systems could operate in diffuse mode, also called scatter mode. This type of system can function when the source and destination are not directly visible to each other. Unlike radio-frequency (RF) wireless links, IR wireless cannot pass through walls. IR wireless is therefore more private than RF wireless.

Numerous reporting features are available. The control system permits the user to categorize data in several ways that generate reports detailing transactions by user as well as by date and time. Reports can be generated based upon date, time, function, activity, location, and/or device. The control system also features dynamic account level encryption.

What is claimed is:

1. A cash room automation device comprising:
at least one safe comprising:
a housing having an interior compartment for securing money, and an outer door having an electronic lock mechanism to control access to said interior compartment;
a control system which controls said electronic lock;
a control system user interface;
a cash recycler controlled by said control system and housed within said safe, said cash recycler capable of authenticating and assigning value to paper currency fed into said cash recycler through a paper currency port accessible from outside said safe and capable of accepting and dispensing a plurality of said paper currency of differing denominations in a single transaction;
a paper currency port housing protruding from said safe; and
means to integrate peripheral units with said control system.

2. The device of claim 1 wherein said cash recycler possesses a plurality of paper currency storage cassettes, each of which can be designated by said control system to receive and dispense a specific denomination of paper currency through said paper currency port.

3. The device of claim 1 wherein said control system grants physical and operational access to said device and peripheral units based upon then entry of user identification data through the user interface and system/group/individual user privileges assigned to each user, authentication of user identification data and verification of user privileges by said control system.

4. The device of claim 3 wherein system/group/individual user privileges are variable through said control system as a function of date and time.

5. The device of claim 4 wherein said system/group/individual user privileges are further configured to prohibit vending, delay the dispensing of tills to cashiers, and vary the amount of money configured to be dispensed in opening tills by date and time.

6. The device of claim 5 wherein said user identification data is selected from the group consisting of biometric data, a personal identification number, a password, a Dallas key, an electronic key, and a card with a magnetic strip.

7. The device of claim 6 wherein the user identification data authentication process can be programmed to require a plurality of user identification data.

8. The device of claim 1 wherein said means to integrate peripheral units with said control system is the communication hardware, software, and a connector interface through which a data communications link is established between said control system and said peripheral devices.

9. The device of claim 8 wherein said connector interface permits a wired connection between said device and said peripheral units.

10. The device of claim 8 wherein said connector interface permits a wireless connection between said device and said peripheral units.

11. The device of claim 1 wherein said user interface comprises a keyboard and display.

12. The device of claim 11 wherein said display comprises a touch-screen with a virtual keyboard generated by said control system.

13. The device of claim 12 wherein a swipe reader is integrated with said user interface.

14. The device of claim 1 wherein the control system is configured to record and report transactional and operational information by date, time, user, and device.

15. The device of claim 14 wherein said control system is further configured to send/receive data with software accounting systems.

16. The device of claim 1 wherein said control system automatically generates an electronic notice to an electronic distribution list when pre-set conditions occur within the device.

17. The device of claim 1 further comprising at least one peripheral unit which manages cash.

18. The device of claim 17 wherein said peripheral unit is selected from the group consisting of bulk coin deposit acceptors, check acceptors, coin vending devices, and paper currency validators.

19. The device of claim 1 wherein said control system is pre-configured to communicate with a plurality of different manufacturer's peripheral devices which can be selected from the user interface.

20. The device of claim 1 wherein said control system is accessible over a wide area network by another computer so as to permit control of said device and access to said control system from a remote location upon authentication of the remote user/computer.

21. The device of claim 1 wherein said control system is programmed to permit an automated clearing of system totals at a specific time, generation of system reports, and roll-over to the next business day.

22. The device of claim 1 wherein said device is arranged so that said safe and said user interface reside on a first side of a wall and said paper currency port and said paper currency port housing extend through said wall from said first side of said wall to a second side of said wall where a user interface resides and is accessible from said second side of said wall yet integrates with said safe and said control system.

23. The method of securing a cash room automation device comprising:
arranging at least one safe comprising:
a housing having an interior compartment for securing money, and an outer door having an electronic lock mechanism to control access to said interior compartment;
a control system which controls said electronic lock;
a control system user interface;
a cash recycler controlled by said control system and housed within said safe, said cash recycler capable of authenticating and assigning value to paper currency fed into said cash recycler through a paper currency port accessible from outside said safe and capable of accepting and dispensing a plurality of said paper currency banknotes of differing denominations according to a user's request;
a paper currency port housing protruding from said safe; and
means to integrate peripheral units with said control system;
within a secure cash room against the wall opposite a cashier accessible area and arranging said device so that said paper currency housing, said paper currency port, and said user interface are accessible across said wall into said cashier accessible area.

24. The method of creating an automated armored car manifest for a cash handling system by placing bar codes on cash handling/storage devices, paper currency/coin storage components of said devices, configuring said control system to associate said bar codes with said devices and said components, programming said control system to calculate and report the amount of money stored in the device/component associated with any system bar code scanned by the user, configuring said control system to debit the ledger for the system/device/component by the amount held in each device/component removed from the system and crediting the ledger for the system/device/component by the amount held in each device/component placed into the system.

25. The method of claim 24 wherein said control system is further configured to print/produce required documentation.
